(19) United States
(12) Patent Application Publication
(10) Pub. No.: US 2009/0238406 A1
(43) Pub. Date: Sep. 24, 2009

(54) Dynamic state estimation

(75) Inventors: Yu Huang, Plainsboro, NJ (US); Joan Llach, Princeton, NJ (US)

Correspondence Address: Thomson Licensing LLC, P.O. Box 5312, Two Independence Way, PRINCETON, NJ, 08543-5312, US

(73) Assignee: Thomson Licensing

(21) Appl. No.: 12/311,266

(22) PCT Filed: Dec. 19, 2006
(86) PCT No.: PCT/US2006/048339

§ 371 Date: Mar. 24, 2009

Related U.S. Application Data
(60) Provisional application No. 60/848,297, filed on Sep. 29, 2006.

(51) Int. Cl. G06K 9/00

(52) U.S. Cl. 382/103

(57) ABSTRACT

According to an implementation, a set of particles is provided for use in estimating a location of a state of a dynamic system. A local-mode seeking mechanism is applied to move one or more particles in the set of particles, and the number of particles in the set of particles is modified. The location of the state of the dynamic system is estimated using particles in the set of particles. Another implementation provides dynamic state estimation using a particle filter for which the particle locations are modified using a local-mode seeking algorithm based on a mean-shift analysis and for which the number of particles is adjusted using a Kullback-Leibler-distance sampling process. The mean-shift analysis may reduce degeneracy in the particles, and the sampling process may reduce the computational complexity of the particle filter. The implementation may be useful with non-linear and non-Gaussian systems.

### CROSS-REFERENCES

This application claims the benefit of U.S. Provisional Patent Application Ser. No. 60/848,297, filed Sep. 29, 2006, and titled “KLD Sampling-Based Particle Filter with Local Mode Seeking by Mean Shift”, which application is incorporated by reference herein in its entirety.

### TECHNICAL FIELD

This disclosure relates to dynamic state estimation.

### BACKGROUND OF THE INVENTION

A dynamic system refers to a system in which a state of the system changes over time. The state may be a set of arbitrarily chosen variables that characterize the system, but the state often includes variables of interest. For example, a dynamic system may be constructed to characterize a video of a soccer game, and the state may be chosen to be the position of the ball. The system is dynamic because the position of the ball changes over time. Estimating the state of the system, that is, the position of the ball, in a new frame of the video is of interest.

### SUMMARY

According to an implementation, a set of particles is provided for use in estimating a location of a state of a dynamic system. A local-mode seeking mechanism is applied to move one or more particles in the set of particles, and the number of particles in the set of particles is modified. The location of the state of the dynamic system is estimated using particles in the set of particles.

The details of one or more implementations are set forth in the accompanying drawings and the description below. Implementations may be, for example, performed as a method, or embodied as an apparatus configured to perform a set of operations or an apparatus storing instructions for performing a set of operations. Other aspects and features will become apparent from the following detailed description considered in conjunction with the accompanying drawings and the claims.

### BRIEF DESCRIPTION OF THE DRAWINGS

FIG. 1 includes a block diagram of a state estimator.

FIG. 2 includes a block diagram of a system for encoding data based on a sate estimated by the state estimator of FIG. 1.

FIG. 3 includes a block diagram of a system for processing data based on a sate estimated by the state estimator of FIG. 1.

FIG. 4 includes a diagram that pictorially depicts various functions performed by an implementation of the state estimator of FIG. 1.

FIG. 5 includes a flow diagram of a process for implementing a particle filter.

FIG. 6 includes a flow diagram of a process for implementing the particle filter of FIG. 5 further including a local-mode seeking mechanism.

FIG. 7 includes a pseudo-code listing for implementing a local-mode seeking mechanism.

FIG. 8 includes a flow diagram of a process for implementing the particle filter of FIG. 6 further including a Kullback-Leibler-distance sampling process.

FIG. 9 includes an illustration depicting the insertion of particles into a KD-tree.

FIG. 10 includes a flow diagram of a process for estimating a state of a system using particles.

### DETAILED DESCRIPTION

As a brief introduction, a particular implementation provides dynamic state estimation using a particle filter (“PF”) for which the particle locations (the particles each give a potential state candidate, which for simplicity is herein often referred to as a location or a position of the particle in the state space) are modified using a local-mode seeking algorithm based on a mean-shift analysis and for which the number of particles is adjusted using a Kullback-Leibler-distance (“KLD”) sampling process. The mean-shift analysis attempts to improve the positions of the particles and, thereby, to reduce the degeneracy problem that is often encountered with a PF. The KLD sampling process attempts to reduce the number of particles used in the PF, and thereby to reduce the computational complexity of the PF, without sacrificing too much quality in the estimation capability of the PF. The implementation may be useful in dealing with non-linear and non-Gaussian systems.

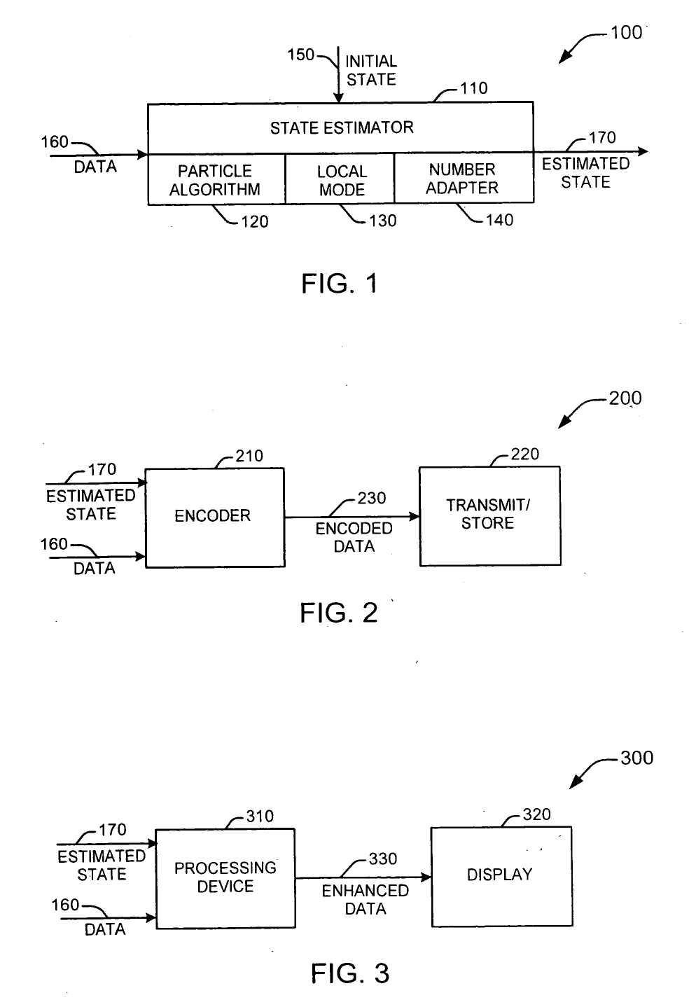

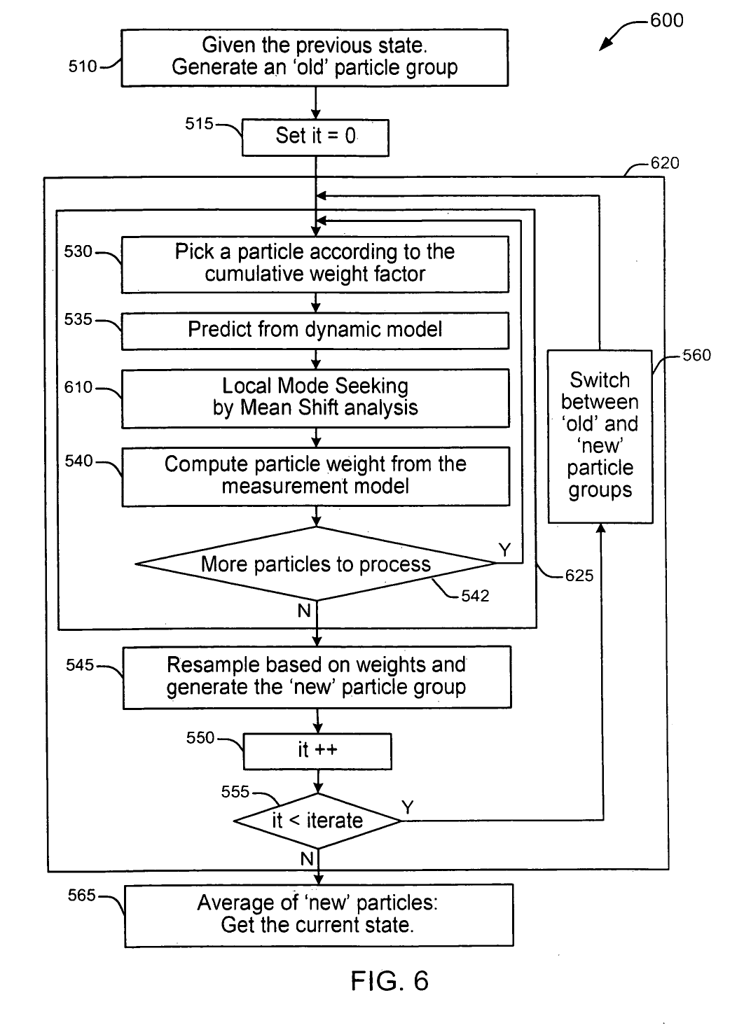

Referring to FIG. 1, in one implementation a system 100 includes a state estimator 110 that may be implemented, for example, on a computer. The state estimator 110 includes a particle algorithm module 120, a local-mode module 130, and a number adapter module 140. The particle algorithm module 120 performs a particle-based algorithm, such as, for example, a PF, for estimating states of a dynamic system. The local-mode module 130 applies a local-mode seeking mechanism, such as, for example, by performing a mean-shift analysis on the particles of a PF. The number adapter module 140 modifies the number of particles used in the particle-based algorithm, such as, for example, by applying a KLD sampling process to the particles of a PF. The operation of an implementation of the modules 120-140 will be described with respect to FIGS. 4-10. The modules 120-140 may be, for ex ample, implemented separately or integrated into a single algorithm.

The state estimator 110 accesses as input both an initial state 150 and a data input 160, and provides as output an estimated state 170. The initial state 150 may be determined, for example, by an initial-state detector or by a manual process. More specific examples are provided by considering a system for which the state is the location of an object in a video. In such a system, the initial object location may be determined, for example, by an automated object detection process using edge detection and template comparison, or manually by a user viewing the video. The data input 160 may be, for example, a sequence of video pictures. The estimated state 170 may be, for example, an estimate of the position of a ball in a particular video picture.

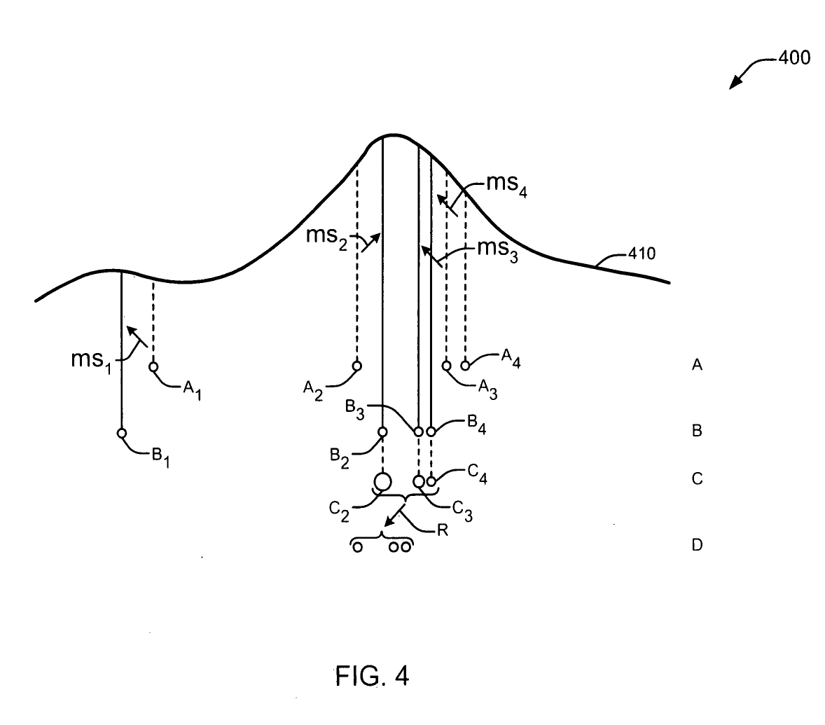

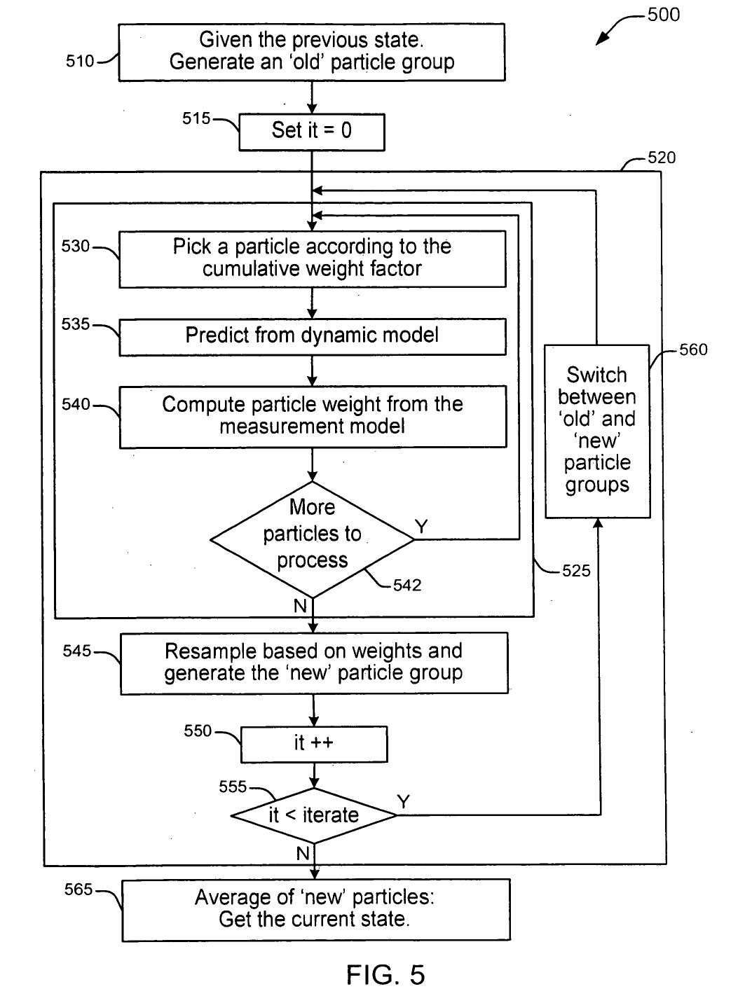

The estimated state 170 may be used for a variety of purposes. To provide further context, several applications are described using FIGS. 2 and 3.

Referring to FIG. 2, in one implementation a system 200 includes an encoder 210 coupled to a transmit/store device 220. The encoder 210 and the transmit/store device 220 may be implemented, for example, on a computer or a communications encoder. The encoder 210 accesses the estimated state 170 provided by the state estimator 110 of the system 100 in FIG. 1, and accesses the data input 160 used by the state estimator 110. The encoder 210 encodes the data input 160 according to one or more of a variety of coding algorithms, and provides an encoded data output 230 to the transmit/store device 220.

Further, the encoder 210 uses the estimated state 170 to differentially encode different portions of the data input 160. For example, if the state represents the position of an object in a video, the encoder 210 may encode a portion of the video corresponding to the estimated position using a first coding algorithm, and may encode another portion of the video not corresponding to the estimated position using a second coding algorithm. The first algorithm may, for example, provide more coding redundancy than the second coding algorithm, so that the estimated position of the object (and hopefully) the object itself) will be expected to be reproduced with greater detail and resolution than other portions of the video.

Thus, for example, a generally low-resolution transmission may provide greater resolution for the object that is being tracked, allowing, for example, a user to view a golf ball in a golf match with greater ease. One such implementation allows a user to view the golf match on a mobile device over a low bandwidth (low data rate) link. The mobile device may be, for example, a cell phone or a personal digital assistant. The data rate is kept low by encoding the video of the golf match at a low data rate but using additional bits to encode the golf ball.

The transmit/store device 220 may include one or more of a storage device or a transmission device. Accordingly, the transmit/store device 220 accesses the encoded data 230 and either transmits the data 230 or stores the data 230.

Referring to FIG. 3, in one implementation a system 300 includes a processing device 310 coupled to a display 320. The processing device 310 accesses the estimated state 170 provided by the state estimator 110 of the system 100 in FIG. 1, and accesses the data input 160 used by the state estimator 110. The processing device 310 uses the estimated state 170 to enhance the data input 160 and provides an enhanced data output 330. The display 320 accesses the enhanced data output 330 and displays the enhanced data on the display 320.

Various implementations enhance data by, for example, highlighting an object. One such implementation highlights a ball (the object) by changing the color of the ball to bright orange. Additionally, various implementations decide whether to enhance data based on the estimated position of an object. In one such implementation, the processing device 310 uses the estimated position of a soccer ball to determine whether the soccer ball has entered a goal. If the soccer ball has entered the goal, then the processing device 310 inserts the word GOAL into the video to alert a user that is watching the soccer game. The processing device 310 may make such a determination by, for example, accessing information on the position of the soccer ball with respect to a field of play, and such information may be determined, for example, from a known position and orientation of a camera.

Implementations of the system 300 may be located, for example, on either a transmitting side or a receiving side of a communications link. In one implementation, the system 300 and the state estimator 110 are on the receiving side, and the state is estimated for the system after receiving and decoding the data. In another implementation, the system 300 and the state estimator 110 are on the transmitting side enhancing the data prior to encoding and transmission, and providing a display of the enhanced data for operators at the transmitting side. In another implementation, the system 300 is on the receiving side, and the state estimator 110 is on the transmitting side which transmits the estimated state 170 and the data input 160. As should be clear, the processing device 310 may be configured as the encoder 210, with the differentially encoded data being the enhanced data.

Referring to FIG. 4, a diagram 400 includes a probability distribution function 410 for a state of a dynamic system. The diagram 400 pictorially depicts various functions performed by an implementation of the state estimator 110. The diagram 400 represents one or more functions at each of levels A, B, C, and D.

The level A depicts the generation of four particles A1, A2, A3, and A4 by a PF. For convenience, separate vertical dashed lines indicate the position of the probability distribution function 410 above each of the four particles A1, A2, A3, and A4.

The level B depicts the shifting of the four particles A1-A4 to corresponding particles B1-B4 by a local-mode seeking algorithm based on a mean-shift analysis. For convenience, solid vertical lines indicate the position of the probability distribution function 410 above each of the four particles B1, B2, B3, and B4. The shift of each of the particles A1-A4 is graphically shown by corresponding arrows MS1-MS4, which indicate the particle movement from positions indicated by the particles A1-A4 to positions indicated by the particles B1-B4, respectively.

The level C depicts weighted particles C2-C4, which have the same positions as the particles B2-B4, respectively. The particles C2-C4 have varying sizes indicating a weighting that has been determined for the particles B2-B4 in the PF. The level C also reflects a reduction in the number of particles, according to a KLD sampling process, in which particle B1 has been discarded.

The level D depicts three new particles generated during a resampling process. The number of particles generated in the level D is the same as the number of particles in the level C, as indicated by an arrow R (R stands for resampling).

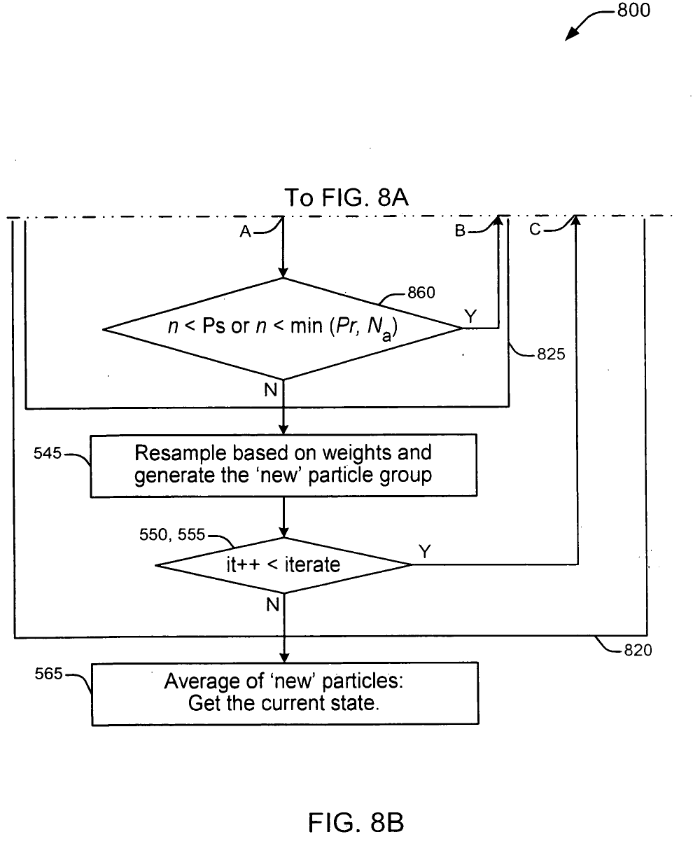

Each of the processes represented by the levels A-D is further described with respect to FIG. 8.

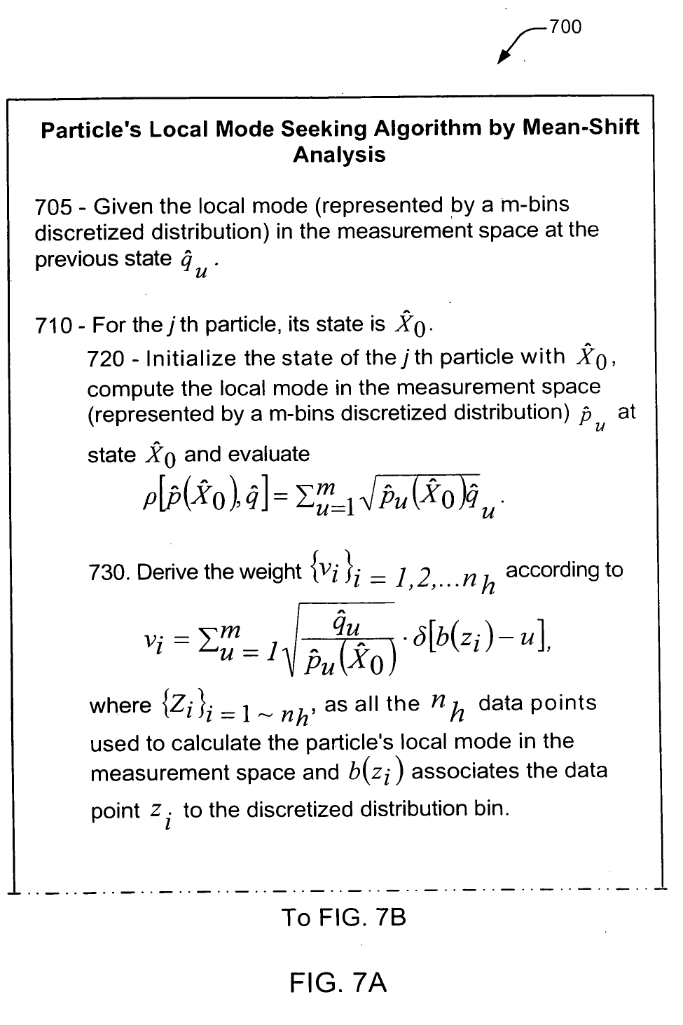

Referring to FIG. 5, one implementation uses a process 500 to estimate states of a system. The process 500 is an example of a process used by a PF to estimate states, but other implementations will operate differently. Before describing the process 500, a short overview of PFs is provided, although the reader is directed to the large body of literature on PFs for further details.

PFs provide a convenient Bayesian filtering framework for estimating and propagating the density of state variables regardless of the underlying distribution and the given system. The density is represented by particles in the state space. In general, a dynamic system is formulated as:

X₁₊₁₁+ƒ(X₁₁,μ₁),

Z₁=g(X₁₁,ξ₁),

where X₁ represents the state vector, Z₁ is the measurement vector; ƒ and g are two vector-valued functions (dynamic model and measurement model, respectively), μ₁ and ξ₁ represent the process (dynamic) and measurement noise, respectively. Both the dynamic model and the measurement model are determined based on the characteristics of the dynamic system.

PFs offer a methodology to estimate the states X₁ recursively from the noisy measurements Z₁. With PFs, state distributions are approximated by discrete random measures composed of weighted particles, where the particles are samples of the unknown states from the state space and the particle weights are computed by Bayesian theory. The evolution of the particle set is described by propagating each particle according to the dynamic model.

Referring again to FIG. 5, the process 500 includes accessing an initial set of particles and cumulative weight factors from a previous state 510. Cumulative weight factors may be generated from a set of particle weights and typically allows faster processing. Note that the first time through the process 500, the previous state will be the initial state and the initial set of particles and weights (cumulative weight factors) will need to be generated. The initial state may be provided, for example, as the initial state 150.

A loop control variable “it” is initialized 515 and a loop 520 is executed repeatedly before determining the current state. The loop 520 uses the loop control variable “it”, and executes “iterate” number of times. Within the loop 520, each particle in the initial set of particles is treated separately in a loop 525. In one implementation, the PF is applied to video of a tennis match for tracking a tennis ball, and the loop 520 is performed a predetermined number of times (the value of the loop iteration variable “iterate”) for every new frame. Each iteration of the loop 520 is expected to improve the position of the particles, so that when the position of the tennis ball is estimated for each frame, the estimation is presumed to be based on good particles.

The loop 525 includes selecting a particle based on a cumulative weight factor 530. This is a method for selecting the remaining particle location with the largest weight, as is known. Note that many particles may be at the same location, in which case it is typically only necessary to perform the loop 525 once for each location. The loop 525 then includes updating the particle by predicting a new position in the state space for the selected particle 535. The prediction uses the dynamic model of the PF.

The loop 525 then includes determining the updated particle's weight using the measurement model of the PF 540. Determining the weight involves, as is known, analyzing the observed/measured data (for example, the video data in the current frame). Continuing the tennis match implementation, data from the current frame, at the location indicated by the particle, is compared to data from the tennis ball's last location. The comparison may involve, for example, analyzing color histograms or performing edge detection. The weight determined for the particle is based on a result of the comparison. The operation 540 also includes determining the cumulative weight factor for the particle position.

The loop 525 then includes determining if more particles are to be processed 542. If more particles are to be processed, the loop 525 is repeated and the process 500 jumps to the operation 530. After performing the loop 525 for every particle in the initial (or “old”) particle set, a complete set of updated particles has been generated.

The loop 520 then includes generating a “new” particle set and new cumulative weight factors using a resampling algorithm 545. The resampling algorithm is based on the weights of the particles, thus focusing on particles with larger weights. The resampling algorithm produces a set of particles that each have the same individual weight, but certain locations typically have many particles positioned at those locations. Thus, the particle locations typically have different cumulative weight factors.

Resampling typically also helps to reduce the degeneracy problem that is common in PFs. There are several ways to resample, such as multinomial, residual, stratified, and systematic resampling. One implementation uses residual resampling because residual resampling is not sensitive to particle order.

The loop 520 continues by incrementing the loop control variable “it” 550 and comparing “it” with the iteration variable “iterate” 555. If another iteration through the loop 520 is needed, then the new particle set and its cumulative weight factors are made available 560.

After performing the loop 520 “iterate” number of times, the particle set is expected to be a “good” particle set, and the current state is determined 565. The new state is determined, as is known, by averaging the particles in the new particle set.

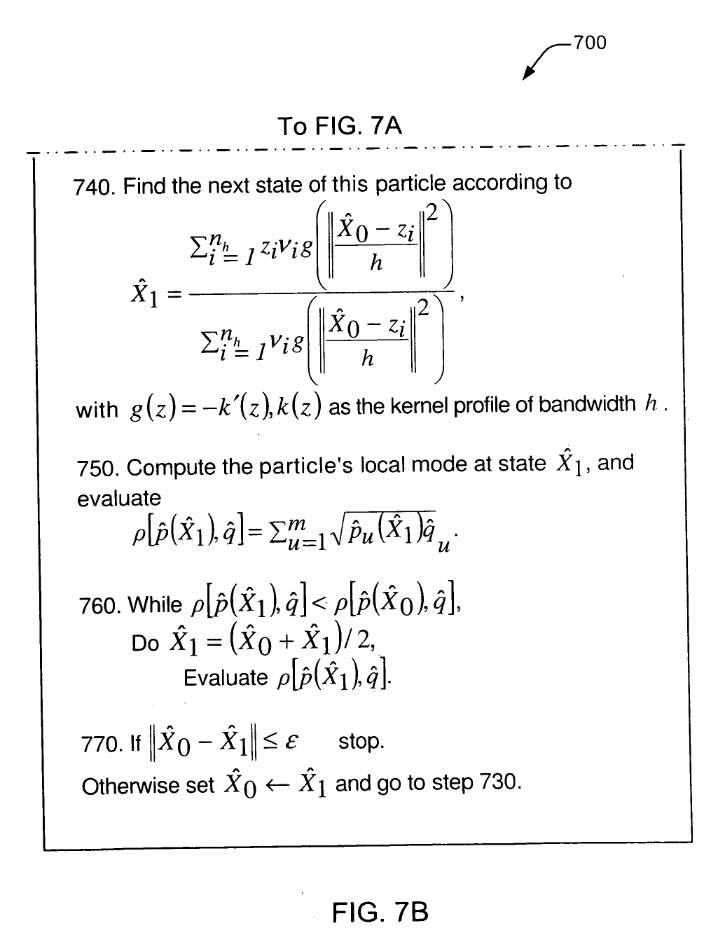

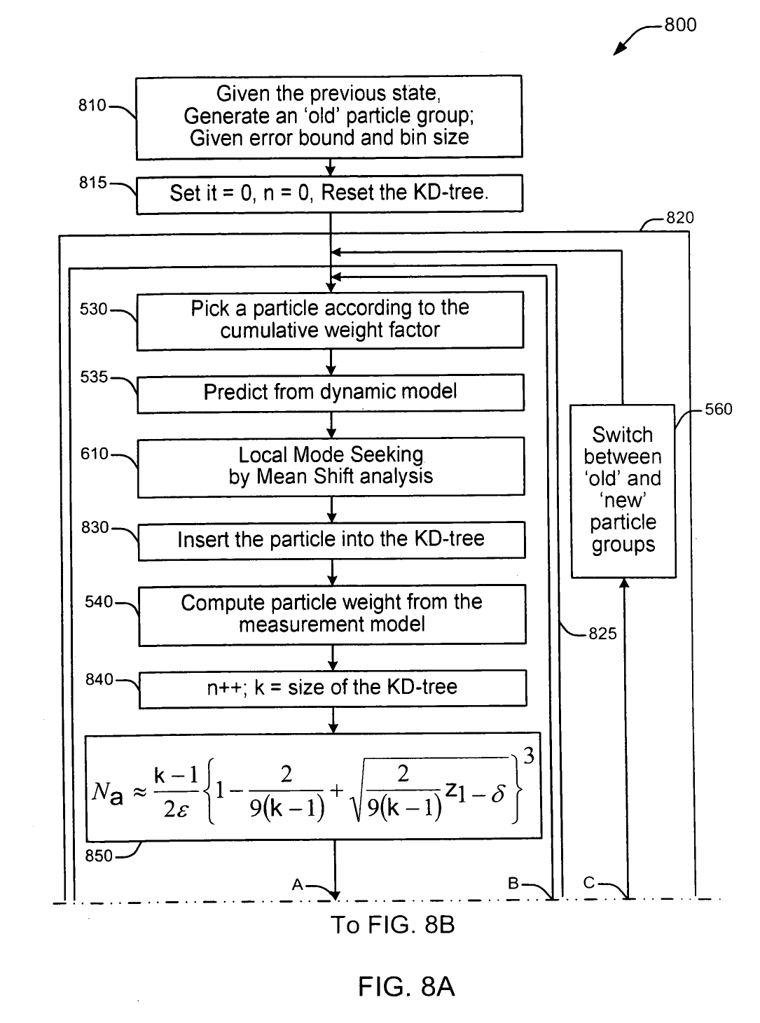

Referring to FIG. 6, one implementation uses a process 600 to estimate states of a system. The process 600 is an example of a process that combines a PF with a local-mode seeking algorithm based on a mean-shift analysis, but other implementations will operate differently. A brief description of local-mode seeking algorithms and mean-shift analysis is provided below and in conjunction with FIG. 7, but the reader is directed to the large body of literature on local-mode seeking using mean-shift analysis for further details.

The mean-shift algorithm is a general non-parametric technique for the analysis of a complex multi-modal state space and for delineating arbitrarily shaped clusters in the state space. The mean-shift algorithm offers a paradigm to overcome the degeneracy problem that is common in PFs.

Referring again to FIG. 6, the process 600 includes many of the same operations as the process 500, and the repeated operations will not be further described in the description of the process 600. However, the process 600 includes an additional operation of performing a local-mode seeking algorithm using a mean-shift analysis 610. The process 600 also includes a loop 620 and a loop 625 which are identical to the loops 520 and 525, respectively, except that the loops 620 and 625 further include performing the local-mode seeking algorithm 610. The local-mode seeking algorithm operates on a gradient principle and iteratively moves a given particle along the gradient, possibly to a local maximum. Such movement produces a particle that is modified based on measurement data, and the modification may improve the prediction of the state of the system.

The “local mode” referred to in the algorithm is a value that is determined for a given particle location. The “local mode” may be computed, for example, based on measured or observed data.

Referring to FIG. 7, a pseudo-code listing 700 provides an example of a process for performing a local-mode seeking algorithm using a mean-shift analysis. In the pseudo-code listing 700:
the current position of a particle is represented by \hat{X}₀,
the next position of a particle is represented by \hat{X}₁,
the local mode at the previous position of a given particle is represented by \hat{q}ᵤ, where “u” is a bin index for a local mode,
the local mode at the current particle position is represented by \hat{p}ᵤ, and
the Bhattacharyya coefficient (“B-coefficient”) is represented by ρ.

The pseudo-code listing 700 begins by assuming that the local mode at the previous position of the particle is available 705, and this local mode refers to a state mode in the measurement space that was estimated at a previous time. The pseudo-code listing 700 then proceeds on a particle-by-particle basis 710. For each particle, the pseudo-code listing 700 determines the local mode at the current position, where the local mode refers to a local maximum in the likelihood distribution, and then determines the B-coefficient associated with that local mode 720.

The pseudo-code listing 700 then determines a mean-shift weight (different from the particle weight in the particle filter framework) for use in shifting the particle 730. The pseudo-code listing 700 then determines the next position for the particle 740, computes the particle's local mode at the next position 750, and calculates the B-coefficient associated with the next local mode 750.

The pseudo-code listing 700 then compares the current B-coefficient with the next B-coefficient 760. If the next B-coefficient is equal to or greater than the current B-coefficient, the listing 700 proceeds to determine if more iterations are needed 770. That determination is based on whether the change in position is greater than a threshold (epsilon). An additional iteration is performed as long as the change in position is greater than the threshold 770.

If the next B-coefficient is less than the current B-coefficient, then the change in position is reduced by a factor of two until the next B-coefficient is not less than the current B-coefficient 760. Then the change in position is evaluated to determine if another iteration is to be performed 770.

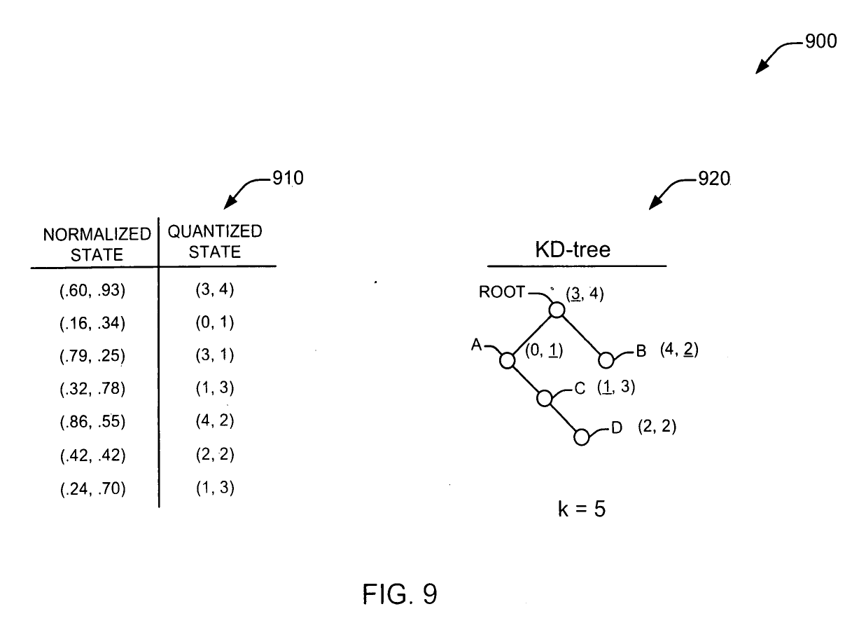

Referring to FIG. 8, one implementation uses a process 800 to estimate states of a system. The process 800 is an example of a process that combines a PF with both (1) a local-mode seeking algorithm based on a mean-shift analysis and (2) a KLD sampling process, but other implementations will operate differently. A brief description of a KLD sampling process, including a KD-tree, is provided below and in conjunction with FIGS. 8-9, but the reader is directed to the large body of literature on KLD sampling processes and KD-trees for further details.

A KLD sampling process is a statistical approach to increase the efficiency of PFs by adapting the size of particle sets during the state estimation process. A key idea is to bind the approximation error introduced by the sample-based representation of the PF. Thus, the PF can choose a smaller number of samples if the density is focused on a small part of the state space and choose a larger number of samples if the state uncertainty is high.

The KLD sampling process described and used in the process 800 is based on a KD-tree structure, where ε (epsilon) is the error bound, 1−δ is the possibility with which the KLD is less than ε (epsilon), and z_{1-δ} is the upper (1−δ) quantile of the standard normal distribution. Both 1−δ and z_{1-δ} are available from standard statistical tables of the normal distribution. Usually, 1−δ is fixed in the KLD sampling process and ε (epsilon) could be adjusted on a case-by-case basis.

A KD-tree is a binary tree to store a finite set of k-dimensional data points. A purpose of a KD-tree is to hierarchically decompose the space into a relatively small number of cells (bins) such that no cell contains too many input data points. In the process 800, a KD-tree structure is used to calculate the number of bins (equal to the size of the KD-tree) for KLD-sampling.

By using a KLD sampling process, the implementation avoids having a fixed number of particles. This typically allows the implementation to use fewer particles than an implementation having a fixed number of particles, and this results in lower computational complexity. Additionally, the adaptability may allow the implementation to increase the number of particles in certain situations where it is needed. Non-adapting systems, on the other hand, that do not have enough particles would be expected to fail in estimating the state if additional particles were needed. For example, an object tracker would fail to track the object. The adaptability of the implementation thus allows the PF to adapt to the characteristics of the estimated state space and to become more efficient in solving the non-linear and non-Gaussian problems in complex dynamic systems.

Referring again to FIG. 8, the process 800 includes many of the same operations as the process 600, and the repeated operations will not be further described in the description of the process 800. However, the process 800 includes numerous additional operations that are described below.

The process 800 includes accessing an initial set of particles and cumulative weight factors from a previous state 810, as well as accessing an error bound and a bin size 810 which may be provided, for example, by a user. A loop control variable “it” and a particle counter “n” are initialized, and a KD-tree is reset 815.

A loop 820 is executed repeatedly before determining the current state. The loop 820 uses a loop control variable “it”, and executes “iterate” number of times. Within the loop 820, particles in the initial set of particles are treated separately in a loop 825. The loops 820 and 825 are analogous to the loops 620 and 625, respectively, with modifications to provide the KLD sampling process.

The loop 825 includes inserting a selected particle into the KD-tree 830, incrementing “n” 840, and determining the current size of the KD-tree, k, 840. The operations of inserting a particle into a KD-tree and determining the size of a KD-tree are illustrated in FIG. 9.

Referring to FIG. 9, an illustration 900 depicts the insertion of seven two-dimensional particles into a KD-tree. The illustration 900 includes a table 910 showing the seven particles with normalized values between 0 and 0.99, and with quantized values. The quantized values are determined by multiplying the normalized values by the number of bins and truncating the fractions, or equivalently by dividing the normalized values by the bin size and truncating the fractions. The number of desired bins is 5, which corresponds to a bin size (assuming equally sized bins) of 0.2. Other implementations, for example, round up or round down, rather than truncating.

The illustration 900 also includes a KD-tree 920 in which the seven quantized particles have been inserted. The quantized particles are taken in order during the insertion process. The first quantized particle is assigned to the root node of the KD-tree 920. Every other quantized particle to be inserted will have its x-coordinate compared to the x-coordinate of the root-node-particle (3, 4). Based on the comparison, the subsequent quantized particles will either (1) go to the left in the tree, if the x-coordinate is less than 3, (2) go to the right in the tree, if the x-coordinate is greater than 3, or (3) be discarded, if the x-coordinate is equal to 3. Thus, the following events occurs while attempting to insert the remaining quantized particles:
The second quantized particle of (0, 1) goes to the left of the root node because 0 is less than 3, and is assigned to node A.
The third quantized particle (3, 1) is discarded at the root node because the x-coordinate is 3. Even though the third quantized particle is discarded, we speak of the third quantized particle as having been inserted into the KD-tree.
The fourth quantized particle (1, 3) goes to the left of the root node because 1 is less than 3. Because only one particle is to be assigned to any given node, the fourth quantized particle must now be compared to the second quantized particle of (0, 1) at node A. At the node A level of the tree, the comparison occurs with the y-coordinates. Thus, the fourth quantized particle goes to the right of node A because 3 is greater than 1, and is assigned to node C. Comparisons with node C, and any other node at this level of the tree, will be done with respect to the x-coordinate. In the KD-tree 920, the particles associated with nodes are shown with one coordinate underlined to indicate the coordinate that is compared at that node. For example, the 3 is underlined in the particle (3, 4) at the root node.
The fifth quantized particle (4, 2) goes to the right of the root node because 4 is greater than 3, and is assigned to node B.
The sixth quantized particle (2, 2) goes to the left of the root node because 2 is less than 3, goes to the right of node A because 2 is greater than 1, and goes to the right of node C because 2 is greater than 1, and is assigned to node D.
The seventh quantized particle (1, 3) goes to the left of the root node because 1 is less than 3, goes to the right of node A because 3 is greater than 1, and is discarded at node C because 1 is equal to 1.

The size of the tree, k, is equal to the number of nodes. The nodes of the KD-tree are the root node and nodes A-D. Thus, k=5.

Other implementations associate multiple particles with a given node rather than discarding the particles.

The loop 825 also includes estimating the number of particles required to achieve the error bound (epsilon) using a known equation 850. The estimate, Na, depends on the size of the tree, k. If k=1, we assume that Na=2. When k>1, we use the equation shown in operation 850 to determine Na. The loop 825 then analyzes “n” in operation 860 to determine if “n” is less than (1) Ps, which is the minimum number of particles that are to be processed in the loop 825, and (2) the minimum of Na and Pr, where Pr is the maximum number of particles that are to be processed in the loop 825. If “n” is less than either Ps or the above minimum, then the loop 825 is repeated for another particle. When “n” is sufficiently large, as determined by the decision operation 860, the process 800 exits the loop 825 and proceeds with the remaining operations shown in FIG. 8 and which have already been described.

Referring again to FIG. 4, it can be seen that the process 800 includes operations for generating the particles at each of the levels A-D. For example, the process 800 includes (1) at least the operations 810 and 545 for generating the particles A1-A4 at the level A of the diagram 400, (2) the local-mode seeking operation 610 for shifting the particles A1-A4 to the positions of the particles B1-B4 at the level B, (3) the weight computation operation 540 for determining weights for the particles B2-B4, resulting in the particles C2-C4 at the level C, (4) the loop 825 for reducing the number of particles, resulting in the discarding of the particle B1 at the level C, and (5) the resampling operation 545 for generating the resampled particles at the level D.

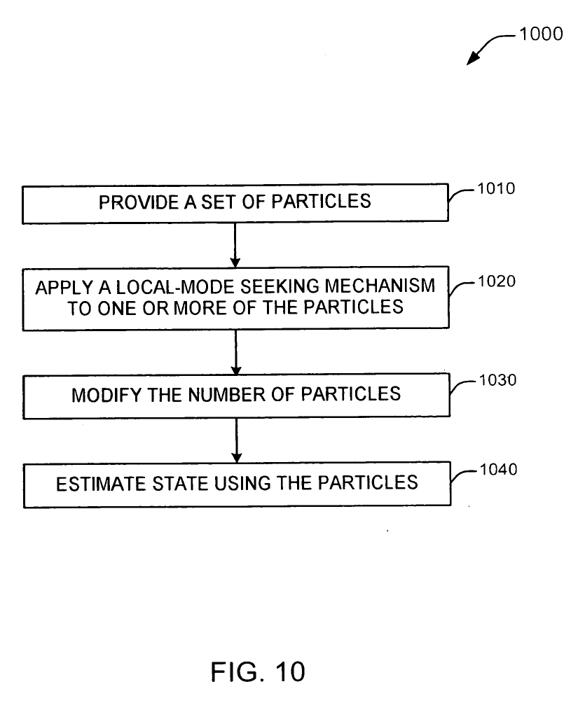

Referring to FIG. 10, one implementation of a particle-based algorithm implements a process 1000 for estimating a state of a system using particles. The process 1000 includes providing a set of particles for use in estimating a location of a state of a dynamic system 1010, which may be implemented by, for example, either of the operations 810 and 545. A local-mode seeking mechanism is applied to move one or more particles in the set of particles 1020, which may be implemented by, for example, the local-mode seeking operation 610. The number of particles in the set of particles is modified 1030, which may be implemented by, for example, the combination of the operations 830, 840, 850, and 860. The location of the state of the dynamic system is estimated using particles in the set of particles 1040, which may be implemented by, for example, the averaging operation 565. The process 1000 is similar in various respects to the process 800, and omits many of the operations in the process 800, clearly showing the optional nature of those operations. Indeed, many of the operations of the process 1000 are also optional.

Further, the process 1000 is a broad process that does not recite the use of PF, a mean-shift analysis, or a KLD sampling process. Rather, the process 1000 requires particles (1010), a local-mode seeking mechanism (1020), and modification of the number of particles (1030). Particle-based algorithms other than PF include, for example, Monte Carlo methods. Local-mode seeking mechanisms may be based on an analysis other than mean-shift analysis, such as, for example, considering edge or gradient information rather than (color) histogram information from the measurements. Algorithms for modifying the number of particles, other than a KLD sampling process, include, for example, an algorithm that thresholds the sum of the weights.

Clearly, the process 1000 could be performed by an implementation that uses a PF, performs a local-mode seeking mechanism using a mean-shift analysis, and modifies the number of particles using a KLD sampling process.

Various implementations also use a dynamic model for a PF that includes a combination of multiple motion models, such as, for example, a random walk model and an auto-regressive (“AR”) model. Several such implementations of a PF include a dynamic model that, at a given iteration of the PF, (1) updates a first portion of the particles using a first motion model and (2) updates a second portion of particles using a second motion model that is different from the first motion model. In one particular implementation that is used for tracking an object in a video, the first motion model is a random walk model and the second motion model is a second-order AR model. This particular object tracking implementation uses the process 500 by modifying operation 535 so that the two motion models are alternated. Such alternating may be provided by, for example, using the random walk model for odd-numbered particles and using the second-order AR model for even-numbered particles.

By using a dynamic model that includes multiple motion models, a PF may provide a set of particles having added diversity, and may therefore produce a better estimate of the current state. Additionally, using multiple motion models may provide for more agile state estimation, including more agile object tracking. The increased agility may arise because state changes may occur that are not well modeled by a single model. For example, unexpected state changes, such as, for example, an unexpected bounce of a basketball off of the top of the backboard, may exhibit behavior that does not fit the motion model used for that state.

Various implementations also use multiple types of data in the measurement model. Accordingly, in various PF implementations multiple types of data are used to calculate the particle weights in the operation 540 of the process 500. In one such PF that is used for tracking an object in a video, the multiple types of data include color histogram data and gradient data (such as, for example, boundaries and edges). The color histogram of the current video picture (or frame) at the particle position is compared to the color histogram of the previous state of the system. Further, gradient data is gathered from the current video picture at the particle position and analyzed to determine if, for example, a portion of a ball appears to be located at the particle position. Considering both the color histogram data and the gradient data may be referred to as fusing multiple cues.

Multiple motion models and fusing multiple cues may be combined in implementations. For example, an object tracking implementation may combine these features, as described below.

In an implementation, the initial distribution of “old” particles is white Gaussian or uniform distribution. Initial particle weights are set to be equivalent. The dynamic model is dependent on the object state vector as:

X=(x,y,\dot{x},\dot{y},w,h,\dot{w},\dot{h}),

where (x, y) is the object window center, (\dot{x},\dot{y}) is its velocity, (w, h) is the window size, and (\dot{w},\dot{h}) is the window scaling velocity, respectively. To make the tracker more eligible for agile motion, we divide particles into two groups. Particles in the first group propagate with a “random walk” model, while particles in the second group are drifted by a second order AR model.

In the mean-shift analysis for each particle, the window size does not change. So mean-shift iteration is applied only to a partial state vector (that is, even though the state is assumed to include both the window size and the window position, only the window position is updated) while the local mode in the measurement space is formulated by the object color histogram.

The measurement model is a combination of the two object cues of color and edge information. A higher priority is given to the color feature due to its robustness in motion blur and cluttered background situations. The likelihood (particle weight) for both features is:

P(z₁|X₁)=P(Z₁^{c}|X₁)P(Z₁^{e}|X₁),

where z₁=[z₁¹,z¹¹], color measurement z₁¹ and edge measurement z₁¹ are assumed to be independent.

Color histogram is used to model the appearance of the object. Its distance metric is the Bhattacharyya distance, equal to 1−ρ[\hat{p}(ŷ₀),\hat{q}], where ρ[\hat{p}(ŷ₀),\hat{q}] is the Bhattacharyya coefficient, so the color measurement likelihood is:

$$P ( {Z}_{t}^{c} \vert {X}_{t} ) = \frac{1}{\sqrt{2 π} {σ }_{c}} exp ( - \frac{- {d }_{B}^{2}}{2 {σ}_{c}^{2}} ) .$$

The edge likelihood comes from edge information around the ellipse defined by the object state, as now explained in more detail. The object shape (for example, the object may be a ball, an eye, a head, a hand) is approximately modeled as an ellipse enclosed tightly by the rectangle window, which is decided by the object state vector. Measurements arising from this ellipse are obtained by edge detection along each ellipse normal on K uniformly sampled ellipse points (for example, K=48). Along each normal, we find the pixel with the biggest edge intensity based on the Sobel/Canny operator. Its distance from the ellipse point on that normal is recorded. The mean of them is d₁=Σᵢdᵢ/K, so the edge likelihood is calculated by:

$$P ( {Z}_{t}^{e} \vert {X}_{t} ) = \frac{1}{\sqrt{2 π} {σ}_{e}} exp ( - \frac{- {d}_{e}^{2}}{2 {σ}_{e}^{2}} ) .$$

Implementations may be well suited for object tracking in sport videos. However, the disclosed concepts and implementations have potential applications in a variety of state estimation problems in dynamic systems, including, for example, automated target recognition, tracking, wireless communications, guidance, noise removal, and financial modeling. In particular, systems that are non-linear and/or non-Gaussian (for example, having a multi-modal distribution) may benefit from the disclosed concepts and implementations.

The modules 120-140 may be implemented, for example, separately or in an integrated hardware unit, including circuitry or other components. Additionally, the modules 120-140 may be implemented on a processing device configured to perform a sequence of instructions for performing the operations of one or more of the modules 120-140. Similarly, the encoder 210, the transmit/storage device 220, and the processing device 230 may be implemented, at least in part, on a processing device configured to perform a sequence of instructions for performing the operations of that component. Such instructions may be stored in the processing device or in another storage device.

As used in this application, “coupled” includes both direct coupling with no intervening elements and indirect coupling through one or more intervening elements. Accordingly, if a set of devices D1-D4 are connected in serial, then D1 and D4 are coupled, even though devices D2 and D3 intervene.

Implementations of the various processes and features described herein may be embodied in a variety of different equipment or applications, particularly, for example, equipment or applications associated with video transmission. Examples of equipment include video coders, video decoders, video codecs, web servers, cell phones, portable digital assistants (“PDAs”), set-top boxes, laptops, and personal computers. As should be clear from these examples, encodings may be sent over a variety of paths, including, for example, wireless or wired paths, the Internet, cable television lines, telephone lines, and Ethernet connections. Additionally, as should be clear, the equipment may be mobile and even installed in a mobile vehicle.

The various aspects, implementations, and features may be implemented in one or more of a variety of manners, even if described above without reference to a particular manner or using only one manner. For example, the various aspects, implementations, and features may be implemented using, for example, one or more of (1) a method (also referred to as a process), (2) an apparatus, (3) an apparatus or processing device for performing a method, (4) a program or other set of instructions for performing one or more methods, (5) an apparatus that includes a program or a set of instructions, and (6) a processor-readable medium.

A component or an apparatus, such as, for example, the state estimator 110, the encoder 210, the transmit/store device 220, and the processing device 310 may include, for example, discrete or integrated hardware, firmware, and/or software. As an example, a component or an apparatus may include, for example, a processor, which refers to processing devices in general, including, for example, a microprocessor, an integrated circuit, or a programmable logic device. As another example, an apparatus may include one or more processor-readable media having instructions for carrying out one or more processes.

A processor-readable medium may include, for example, a software carrier or other storage device such as, for example, a hard disk, a compact diskette, a random access memory (“RAM”), or a read-only memory (“ROM”). A processor-readable medium also may include, for example, formatted electromagnetic waves encoding or transmitting instructions. Instructions may be, for example, in hardware, firmware, software, or in an electromagnetic wave. Instructions may be found in, for example, an operating system, a separate application, or a combination of the two. A processor may be characterized, therefore, as, for example, both a device configured to carry out a process and a device that includes a processor-readable medium having instructions for carrying out a process.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application and are within the scope of the following claims.

1. A method comprising:
providing a set of particles for use in estimating a location of a state of a dynamic system;
applying a local-mode seeking mechanism to move one or more particles in the set of particles;
modifying the number of particles in the set of particles; and
estimating the location of the state of the dynamic system using particles in the set of particles.

2. The method of claim 1 wherein the particle-based algorithm comprises a particle filter algorithm.

3. The method of claim 1 wherein the local-mode seeking mechanism comprises a mean-shift analysis process.

4. The method of claim 1 wherein adapting the number of particles comprises using a Kullback-Leibler-distance (“KLD”) sampling process.

5. The method of claim 4 further comprising using a KD-tree structure to estimate a number of bins in the KLD sampling process.

6. The method of claim 5 wherein using the KD-tree structure comprises inserting particles into a KD-tree, the particles include a dimension, and inserting particles comprises:
quantizing the dimension of a given particle to produce a quantized value for the given particle,
inserting the given particle into the KD-tree by associating the given particle with a node in the KD-tree,
quantizing the dimension of a different particle to produce a quantized value for the different particle,
comparing the quantized value for the given particle and the quantized value for the different particle, and
determining whether to discard the different particle based on a result of comparing the two quantized values.

7. The method of claim 6 wherein determining whether to discard the different particle comprises discarding the different particle if the quantized value for the different particle is the same as the quantized value for the given particle.

8. The method of claim 1 wherein:
the particle-based algorithm comprises a particle filter algorithm,
the mechanism comprises a mean-shift analysis process, and
adapting the number of particles comprises using a Kullback-Leibler-distance (“KLD”) sampling process.

9. The method of claim 1 wherein adapting the number of particles is performed after applying the mechanism to move the particles.

10. The method of claim 1 wherein:
the particle-based algorithm comprises a particle filter algorithm, and
multiple types of data are used to calculate the particle weights.

11. The method of claim 10 wherein:
the particle filter algorithm is used for tracking an object in a video, and
the multiple types of data include color histogram data and gradient data.

12. The method of claim 1 wherein:
the particle-based algorithm comprises a particle filter algorithm, and
the particle filter algorithm includes a dynamic model that, at a given iteration of the particle filter algorithm, (1) updates a first portion of particles using a first motion model and (2) updates a second portion of particles using a second motion model that is different from the first motion model.

13. The method of claim 12 wherein:
the particle filter algorithm is used for tracking an object in a video,
the first motion model comprises a random walk model, and
the second motion model comprises a second-order auto-regressive model.

14. The method of claim 1 wherein the particle-based algorithm uses measurements of data.

15. The method of claim 1 wherein the particle-based algorithm is used for tracking an object in a video, the state of the dynamic system includes a position of the object, and the method further comprises:
providing an estimated position of the object to an encoder,
encoding a portion of the video corresponding to the estimated position using a first coding algorithm, and
encoding another portion of the video not corresponding to the estimated position using a second coding algorithm.

16. The method of claim 1 wherein the particle-based algorithm is used for tracking an object in a video, the state of the dynamic system includes a position of the object, and the method further comprises:
providing an estimated position of the object to a processing device,
modifying the video, by the processing device, using the estimated position of the object to enable an enhanced display of the object.

17. The method of claim 16 wherein the enhanced display includes highlighting the object in the video.

18. The method of claim 1 further comprising, prior to applying the local-mode seeking mechanism, moving one or more particles in the set of particles by updating the one or more particles using a dynamic model.

19. The method of claim 1 further comprising, after modifying the number of particles, and prior to estimating the location of the state, moving one or more particles in the set of particles by resampling the set of particles.

20. An apparatus comprising a processing device configured:
to provide a set of particles for use in estimating a location of a state of a dynamic system,
to apply a local-mode seeking mechanism to move one or more particles in the set of particles,
to modify the number of particles in the set of particles, and
to estimate the location of the state of the dynamic system using particles in the set of particles.

21. The apparatus of claim 20 wherein:
the processing device is further configured (1) to track an object in a video, with the state of the dynamic system including a position of the object and (2) to provide an estimated position of the object, and
the apparatus further comprises an encoder configured (1) to receive the estimated position of the object from the processing device, (2) to encode a portion of the video corresponding to the estimated position using a first coding algorithm, and (3) to encode another portion of the video not corresponding to the estimated position using a second coding algorithm.

22. The apparatus of claim 20 wherein:
the processing device is further configured (1) to track an object in a video, with the state of the dynamic system including a position of the object, and (2) to provide an estimated position of the object, and
the apparatus further comprises a post-processing device configured (1) to receive the estimated position of the object from the processing device, and (2) to modify the video using the estimated position of the object to enable an enhanced display of the object.

23. An apparatus comprising:
means for providing a set of particles for use in estimating a location of a state of a dynamic system;
means for applying a local-mode seeking mechanism to move one or more particles in the set of particles;
means for modifying the number of particles in the set of particles; and
means for estimating the location of the state of the dynamic system using particles in the set of particles.

24. An apparatus comprising a processor-readable medium having stored thereon instructions for causing one or more processing devices to perform:
providing a set of particles for use in estimating a location of a state of a dynamic system;
applying a local-mode seeking mechanism to move one or more particles in the set of particles;
modifying the number of particles in the set of particles; and
estimating the location of the state of the dynamic system using particles in the set of particles.
